(19) United States
(12) Patent Application Publication
(10) Pub. No.: US 2014/0166672 A1
(43) Pub. Date: Jun. 19, 2014

(54) Container Thermal Core And Closure Remover

(71) Applicant: Owens-Brockway Glass Container Inc., (US)

(72) Inventor: Peter Lodewijk Albert Stroucken, Toledo, OH (US)

(73) Assignee: Owens-Brockway Glass Container Inc., Perrysburg, OH (US)

(21) Appl. No.: 13/798,397

(22) Filed: Mar. 13, 2013

Related U.S. Application Data
(63) Continuation-in-part of application No. 13/658,883, filed on Oct. 24, 2012.
Application No. 13/658,883 is a continuation-in-part of application No. 13/325,923, filed on Dec. 14, 2011.

(51) Int. Cl. B65D 81/18; B67B 7/00

(52) U.S. Cl. CPC B65D 81/18; B67B 7/00
USPC 220/592.01; 81/3.45; 81/3.15

(57) ABSTRACT

A thermal core includes a hollow body with at least one engagement element for engaging a corresponding engagement element on a container, a central portion for heat-transfer with a container base, a thermal medium within the hollow body, a bottom wall on the hollow body, and at least one pocket in the bottom wall with at least one of twist-off features or pry-off features. A product to remove a closure from a container includes a wall, and a multi-functional pocket in the wall that includes laterally spaced and diametrically overlapping semi-circumferential pockets including a first pocket having container closure pry-off features and a second pocket having container closure twist-off features.

This application is a continuation-in-part of application Ser. No. 13/658,883 filed Oct. 24, 2012, which is a continuation-in-part of application Ser. No. 13/325,923 filed Dec. 14, 2011, the disclosures of which are incorporated herein by reference.

The present disclosure is directed to a device to facilitate removal of a closure from a container and to help maintain a cool temperature in a food or beverage such as beer, wine, or soda, or a warm temperature in coffee, for example, after the food or beverage has been removed from a chilling or heating environment.

### BACKGROUND AND SUMMARY OF THE DISCLOSURE

A general object of the present disclosure is to provide a device for securement to the bottom of a food or beverage container, which device may be used as a closure remover and/or can be readily chilled to a low temperature such as in a cooler or freezer, or heated to elevated temperature such as in a microwave. The device may be readily assembled to a container, and may draw heat from or add heat to the container for an extended period of time so as to maintain a desired temperature of a food or beverage in the container.

The present disclosure embodies a number of aspects that can be implemented separately from or in combination with each other.

A product in accordance with one aspect of the present disclosure includes a container having a body with a sidewall, a base, at least one external engagement element on the sidewall or the base, a neck finish, and a closure on the neck finish. The server also includes a thermal core that includes a hollow body with at least one internal engagement element for engaging the external engagement element on the container to retain the thermal core on the container, a central portion for heat-transfer with the base, a thermal medium within the hollow body, a bottom wall on the hollow body, and at least one pocket in the bottom wall with means for engaging the closure and removing the closure from the neck finish.

In accordance with another aspect of the present disclosure, a thermal core includes a hollow body with at least one engagement element for engaging a corresponding engagement element on a container, a central portion for heat-transfer with a container base, a thermal medium within the hollow body, a bottom wall on the hollow body, a domed portion in the bottom wall, and a pocket in the domed portion having at least one of twist-off features or pry-off features.

In accordance with a further aspect of the present disclosure, a product to remove a closure from a container includes a wall, and a multi-functional pocket in the wall that includes laterally spaced and diametrically overlapping semi-circumferential pockets including a first pocket having container closure pry-off features and a second pocket having container closure twist-off features.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is an elevational view of a food or beverage server in accordance with an exemplary embodiment of the present disclosure;

FIG. 2 is an elevational view similar to that of FIG. 1 but showing a thermal core of the server in section;

FIG. 3 is a fragmentary exploded perspective view of the server of FIGS. 1-2;

FIG. 4 is a perspective view of the thermal core of FIG. 2;

FIG. 5 is an elevational view of a server in accordance with a second exemplary embodiment of the disclosure;

FIG. 6 is an exploded fragmentary perspective view of the server in FIG. 5;

FIG. 7 is an exploded elevational view of a server in accordance with a further exemplary embodiment of the disclosure;

FIG. 8 is a fragmentary exploded perspective view of a server in accordance with yet another exemplary embodiment of the disclosure;

FIG. 9 is a partially sectioned elevational view of a server in accordance with a further exemplary embodiment of the disclosure;

FIG. 10 is an enlarged view of a portion of FIG. 9;

FIG. 11 is a fragmentary view of the portion of FIG. 10 within the circle 11;

FIG. 12 is a fragmentary exploded view of the server in FIGS. 9-11;

FIG. 13 is a top plan view of the server in the embodiment of FIGS. 9-12;

FIG. 14 is a sectional view taken substantially along the line 14-14 in FIG. 13;

FIG. 15 is a partially sectioned elevational view of a server in accordance with yet another exemplary embodiment of the disclosure;

FIG. 16 is an enlarged view of a portion of FIG. 15;

FIG. 17 is a bottom perspective view of a thermal core in accordance with another illustrative embodiment of the present disclosure;

FIG. 18 is a top perspective view of the thermal core of FIG. 17;

FIG. 19 is an enlarged, fragmentary, cross-sectional view of a server including a container and the thermal core of FIGS. 17 and 18 coupled to the container;

FIG. 20 is a fragmentary, schematic view of a server in accordance with another illustrative embodiment of the present disclosure, including a thermal core coupled to a container and being used to remove a closure from another container;

FIG. 21 is a fragmentary, schematic view of the server of FIG. 20 being used to reapply the closure to the other container; and

FIG. 22 is a bottom view of a thermal core in accordance with another illustrative embodiment of the present disclosure.

### DETAILED DESCRIPTION OF PREFERRED EMBODIMENTS

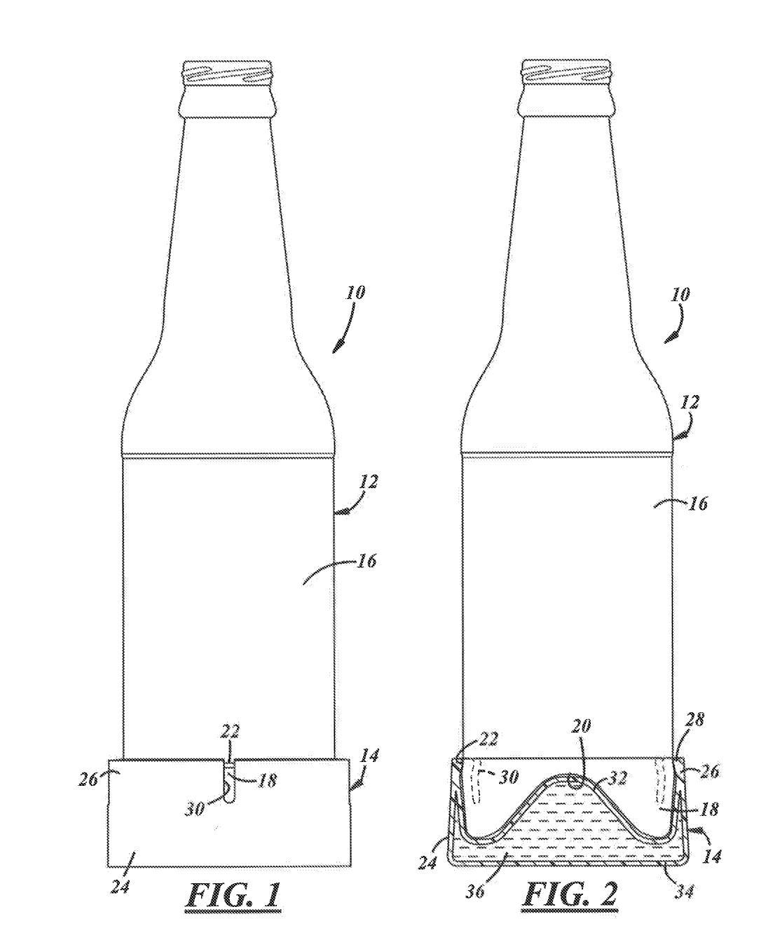

FIGS. 1-4 illustrate a server 10 in accordance with an exemplary embodiment of the disclosure as including an assembly of a container 12 and a thermal core 14 secured to a base of the container. (The term “thermal core” refers to a device that is cooled to chill a food or beverage in the container, or is heated to heat the food or beverage in the container.) Container 12 can be a bottle of glass, plastic, or metal construction, for example, and includes a body having a sidewall 16, a base 18 and a push-up 20. Base 18 preferably is substantially cylindrical. An external engagement element in the form of a radially outwardly extending shoulder 22 extends around base 18 beneath sidewall 16. The geometry of the body as well as the container shoulder, neck and neck finish in FIGS. 1-2 are exemplary only.

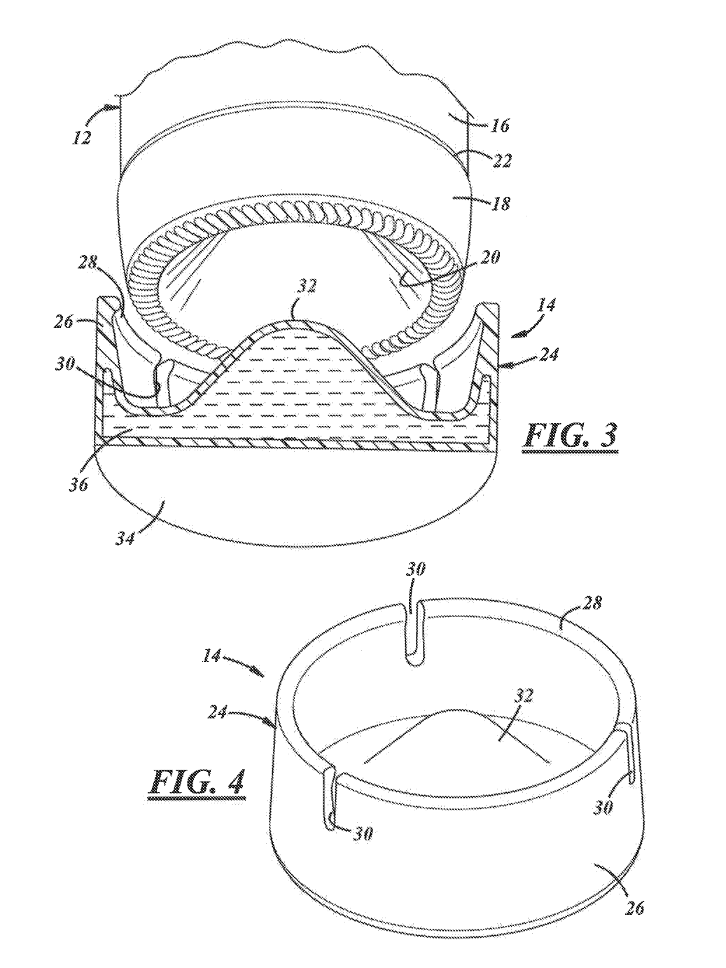

With reference to FIGS. 2-3, the thermal core 14 includes a hollow body 24, preferably of plastic construction. Body 24 includes an axially extending annular peripheral wall 26 having an internal bead 28 positioned and sized for snap-receipt over shoulder 22 of container 12. There preferably are a plurality of angularly spaced longitudinal slots 30 in peripheral wall 26 segmenting bead 28 and facilitating radial expansion of wall 26 as bead 28 is snapped over shoulder 22. A central dome 32 of body 24 preferably is sized for heat-transfer facing-contact engagement with the external surface of container push-up 20. Push-up 20 can be somewhat deeper than usual to enhance such heat transfer. Body 24 also has a bottom wall 34 that can be flat or of other suitable geometry such as slightly domed.

A thermal medium 36, such as a fluid medium, is contained within hollow body 24. Medium 36 can be a chillable medium such as a freezable saline solution. A chillable medium alternatively could be a suitable refrigerant, water or another suitable substance. Medium 36 alternatively can be a heatable medium such as sand, oil or a saline solution.

In use, thermal core 14 can be stored in a suitable environment to maintain desired temperature. For example, core 14 can be stored in a freezer or ice chest so that medium 36 is cooled and preferably frozen solid. For use, the thermal core 14 is removed from the freezer or ice chest and assembled over the base of a beer, wine cooler or soda container, for example. As another example, thermal core 14 can be stored in a heated and/or insulated environment. Heat transfer between medium 26 and the contents of the container 12, through dome 32 and push-up 20, helps maintain a desired temperature of the liquid within the container 12. The medium-filled cavity of body 24 preferably extends around at least a portion of the base chime area, as best seen in FIG. 2, further to enhance such heat transfer. In addition, bottom wall 34 of thermal core 14 acts as a coaster to help prevent flow of condensate, for example, from the external surface of the container onto a table or the like.

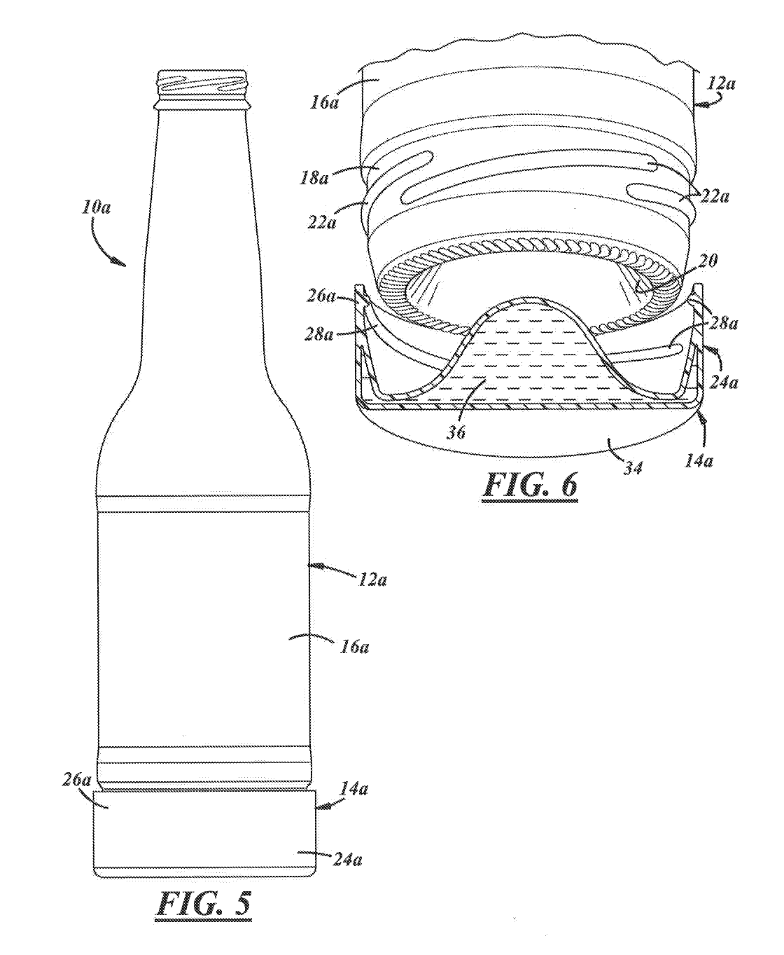

FIGS. 5 and 6 illustrate a server 10a comprising a thermal core 14a assembled to the base of a container 12a. In this embodiment, container 12a has a cylindrical base 18a (FIG. 6) recessed radially inwardly from the container sidewall 16a. With reference to FIG. 6, there is a push-up 20 in container 12a, and a circumferential array of thread segments 22a on a radially outwardly facing portion of base 18a beneath sidewall 16a. Thermal core 14a includes a hollow plastic body 24a having an annular peripheral wall 26a with at least one internal thread segment 28a for engagement with external thread segments 22a to retain core 14a on container 12a. A suitable medium 36 is contained within hollow body 24a. Thus, in this embodiment, after chilling or heating, thermal core 14a can be threaded onto base 18a of container 12a.

FIG. 7 illustrates a server thermal core 14b that is similar in many respects to server thermal core 14 in FIGS. 1-4 except that the central portion of the plastic body 24b is concave at 40 for heat-exchange facing engagement with an outwardly extending dome 42 on the base of container 12b.

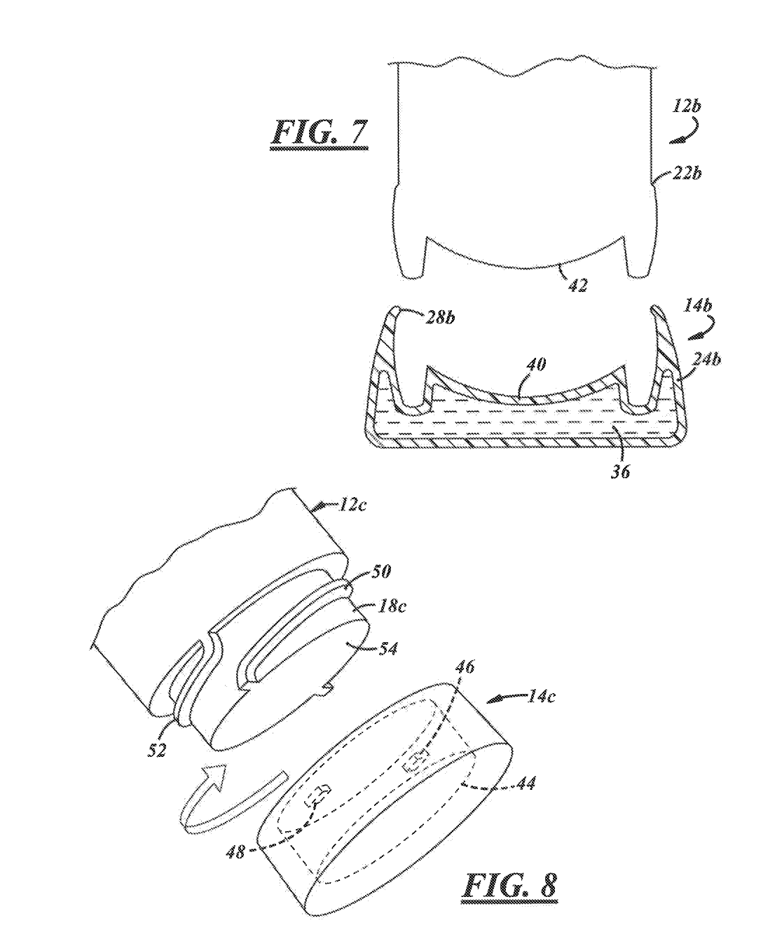

FIG. 8 illustrates a server thermal core 14c that has a cylindrical pocket 44 with opposed radially inwardly extending bayonet tabs 46, 48. Pocket 44 of server 14c provides a flat surface for opposed heat-transfer facing contact with a flat surface 54 on base 18c of container 12c. Base 18c of container 12c has a pair of helical thread-like engagement elements 50, 52. Thus, server 14c is adapted to be secured to base 18c of container 12c by a bayonet lock arrangement wherein tabs 46, 48 are fitted over and locked to thread elements 50, 52 so that the thermal medium within core 14c can chill or heat the contents of container 12c.

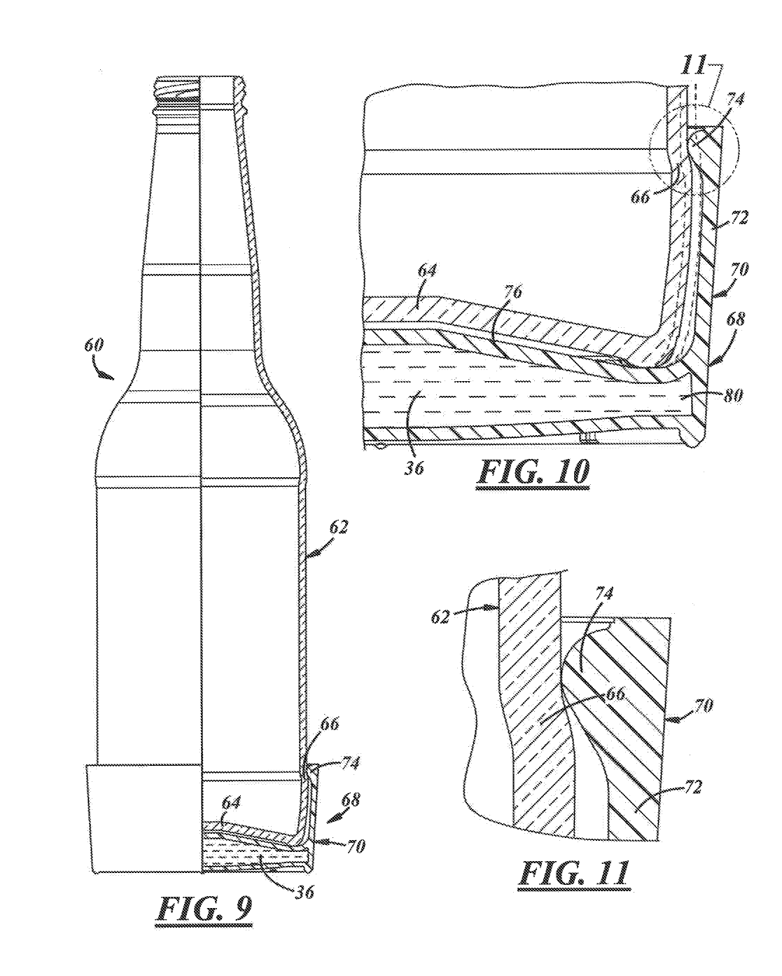

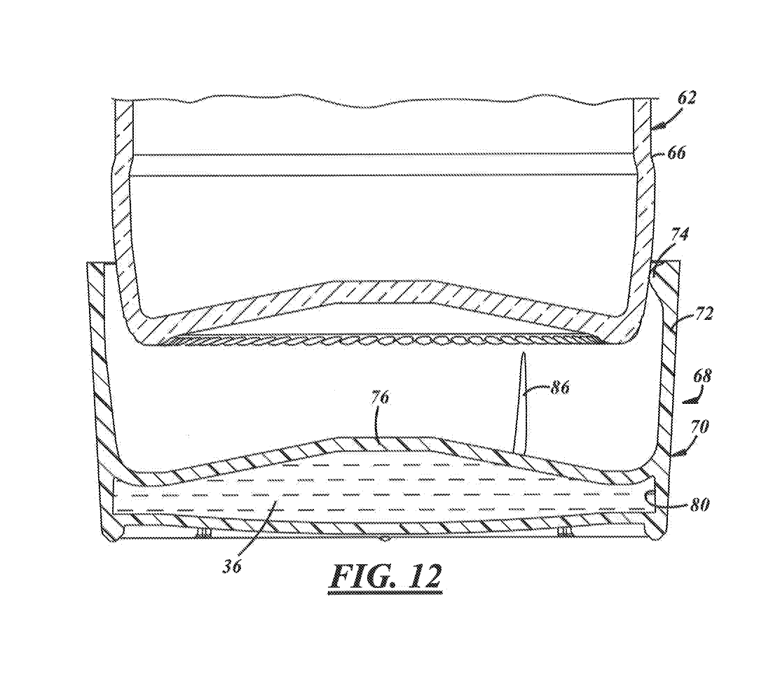

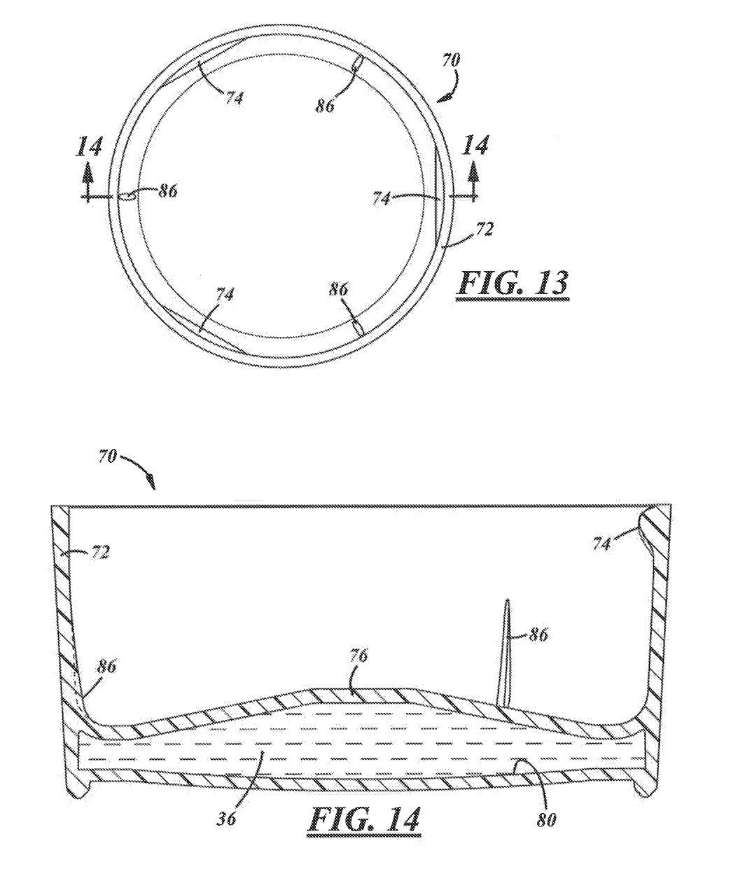

FIGS. 9-14 illustrate a server 60 as including a container 62 having a base 64 and an external shoulder 66 adjacent to base 64. A thermal core 68 includes a shell 70 that preferably is of plastic construction. With reference to FIGS. 10 and 11, shell 70 has a circumferential wall 72 with an internal bead 74 adapted for receipt by snap fit over shoulder 66 on container 62. A lateral wall 76 of shell 70 is in engagement with or closely spaced from base 64 of container 62. Shell 70 has a hollow cavity 80 in which thermal material 36 is disposed. With reference to FIG. 12, wall 72 of shell 70 can have angularly spaced internal strengthening ribs 86. Bead 74 on shell 70 can be circumferentially continuous, or can be circumferentially segmented as illustrated in FIG. 13.

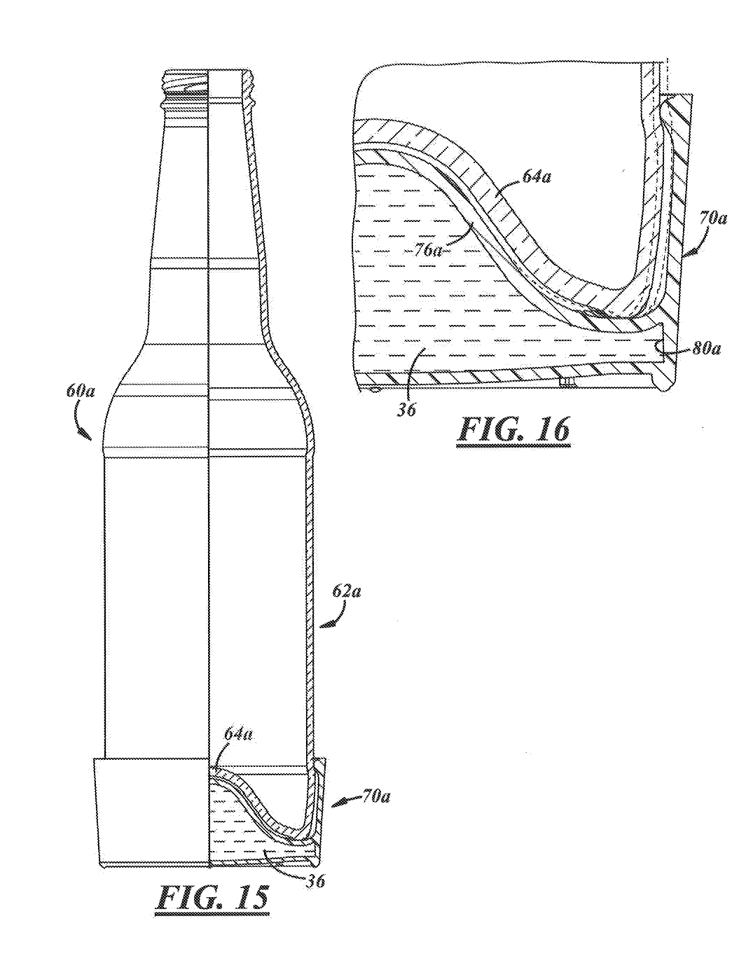

FIGS. 15 and 16 illustrate a server 60a that is similar to server 60 in FIGS. 9-14 except that base 64a of container 62a has a deep push-up or punt as compared with the relatively shallow dome or push-up base 64 of container 62. Shell 70a has a correspondingly contoured wall 76a for either face-to-face or closely spaced heat-transfer positioning relative to base 64a.

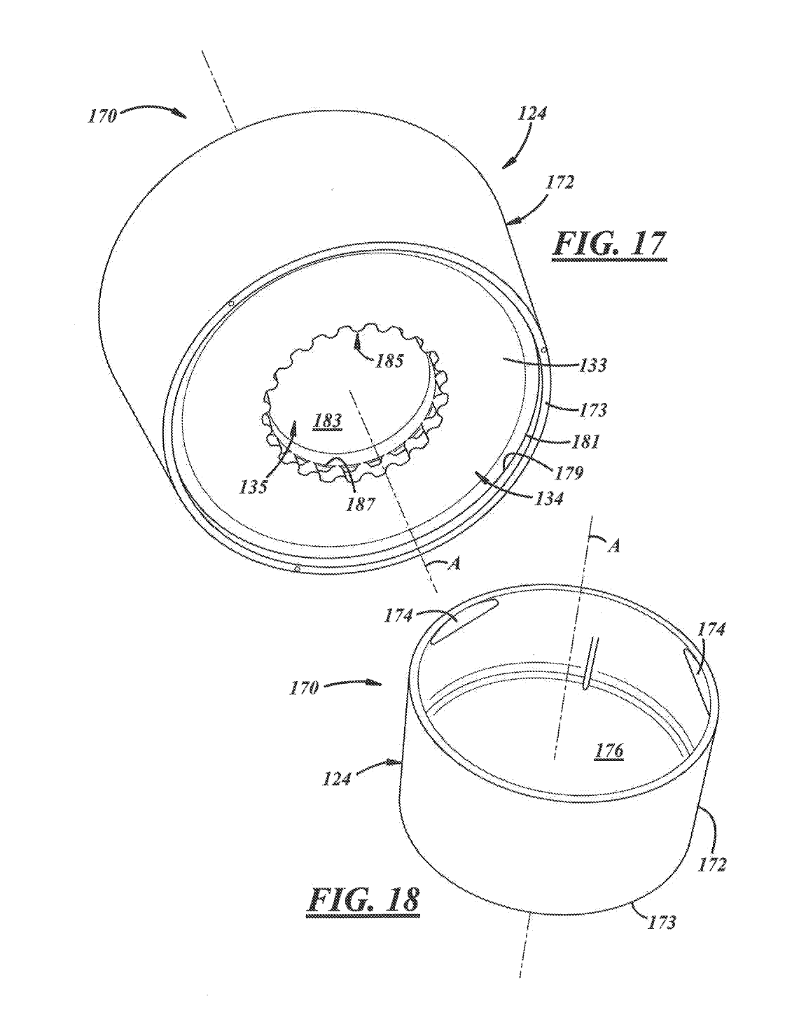

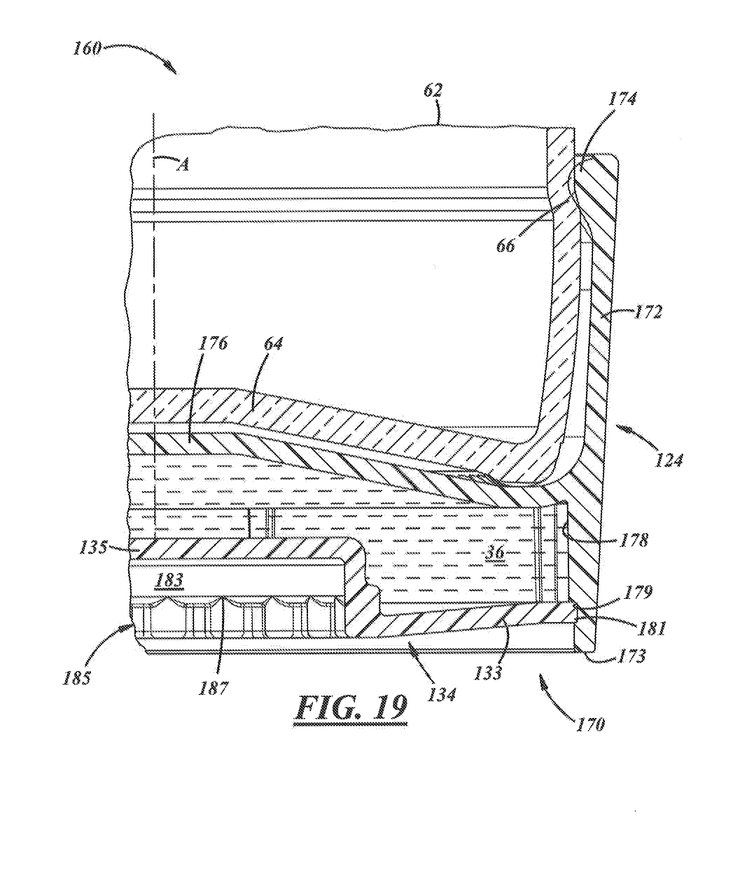

FIGS. 17-19 show another illustrative embodiment of a server 160 (FIG. 19) including the container 62 (FIG. 19) and a shell or thermal core 170 coupled to the container 62. This embodiment is similar in many respects to the embodiment of FIGS. 1-16 and like numerals among the embodiments generally designate like or corresponding elements throughout the several views of the drawing figures. Accordingly, the descriptions of the embodiments are incorporated into one another, and description of subject matter common to the embodiments generally may not be repeated here.

By way of background, a container closure (not shown), like a bottle cap, is applied to an open end of a bottle during a capping operation of a bottling process. Capping typically involves placing the bottle cap onto the open end of the bottle and crimping the closure onto the bottle to seal the bottle and protect the contents of the bottle from contamination and spillage. The closure may be crimped so as to form either a twist-off closure or a pry-off closure. The ply-off type cap usually requires use of a tool to remove the closure from the bottle. Although a twist-off closure may not require a tool for removal, the crimping operation can result in the formation of rough metal edges on the closure.

Accordingly, and with general reference to FIGS. 17-19, the thermal core 170 may double as a bottle opener or closure remover, including twist-off and/or pry-off features as will be discussed in greater detail herein below. The thermal core 170 includes a hollow body 124 having a central longitudinal axis A, and a generally axially extending circumferential outer wall 172 with one or more internal beads 174 (FIGS. 18-19) for receipt by snap fit over the shoulder 66 on the container 62 (FIG. 19). The thermal core 170 also includes a lateral wall 176 (FIGS. 18-19) extending radially inwardly from the outer wall 172 across the axis A and in engagement with or closely spaced from the base 64 of the container 62 (FIG. 19).

With particular reference to FIG. 19, the thermal core 170 also includes a bottom wall 134 that may be a component separate from the body 124 and sealingly coupled thereto to establish a hollow cavity 178 of the core 170 in which thermal material 36 is contained. The outer wall 172 includes a lower end 173 and also may include an annular internal recess 179 to accept a radially outer portion 181 of the bottom wall 134. The bottom wall 134 may be press fit or interference fit to the body 124, snap fit to the body 124, adhered to the body 124, melted or welded to the body 124, and/or threaded to the body 124, or coupled thereto in any other suitable manner so as to form a seal to contain the thermal material 36. More specifically, in the illustrated embodiment, the radially outer portion 181 of the wall 134 may be coupled to the outer wall 172 within the recess 179. Accordingly, the wall 134 may be axially recessed within the body 124. In other embodiments, the wall 134 may be coupled directly to the lower end 173 of the body 124, or in a manner flush therewith, or in any other suitable location and manner.

Still referring to FIG. 19, the bottom wall 134 may include a base portion 133 extending radially inwardly from the body 124, and a domed portion 135 that may extend radially inwardly from the base portion 133 and axially upwardly or toward the lateral wall 176 of the body 124. Accordingly, the bottom wall 134 may include a pocket 183 that may be established by the domed portion 135 to engage and remove a closure (not shown) from the container 62. The pocket 183 may include a circumferential pattern in the shape of a radially outer profile of a crown closure. For example, the pocket 183 may have a corrugated or serrated circumferential internal profile 185 in a radially inwardly facing surface 187 of the dome 135. The profile 185 may include a circumferential array of radially inwardly extending projections circumferentially interspersed with radially outwardly extending reliefs that may correspond to an outer circumferential profile of a crown closure or cap (not shown). The pocket 183 may be tapered from the open end in a radially inward direction, and/or may be sized in such a manner so as to frictionally retain a corresponding container closure therein after the closure has been removed from the container 62. In the illustrated embodiment, the domed portion 135 may be axially spaced from the lower end 173 of the body 124 so as to be axially recessed within the body 124.

In use, the core 170 may be removed from the container 62 and positioned over a closure on the container 62. The closure may be inserted into the pocket 183 of the wall 134 and engaged with the serrated profile 185. Also, the core 170 may be rotated about its axis A relative to the container 62 to remove the closure from the container 62, for example, in a twist-off or unthreading manner. Likewise, the entire server 160, including the container 62 and the core 170, can be used to remove a closure on another container (not shown) without having to remove the core 170 from the container 62.

In any case, the relatively large diameter of the core 170 provides good leverage to remove a container closure and eliminates the need for a separate bottle opener. Also, the pocket 183 may provide a decorative feature to the core 170. Once removed from the container 62, a closure may be retained in the pocket 183, or may be removed or knocked loose therefrom. In any case, the core 170 may be returned to the bottom of the container 62. Because the domed portion 135 is spaced from the lower end 173 of the body 124, any closure retained in the pocket 183 may be carried flush or recessed from the body end 173 such that the core 170 will rest flat on a surface.

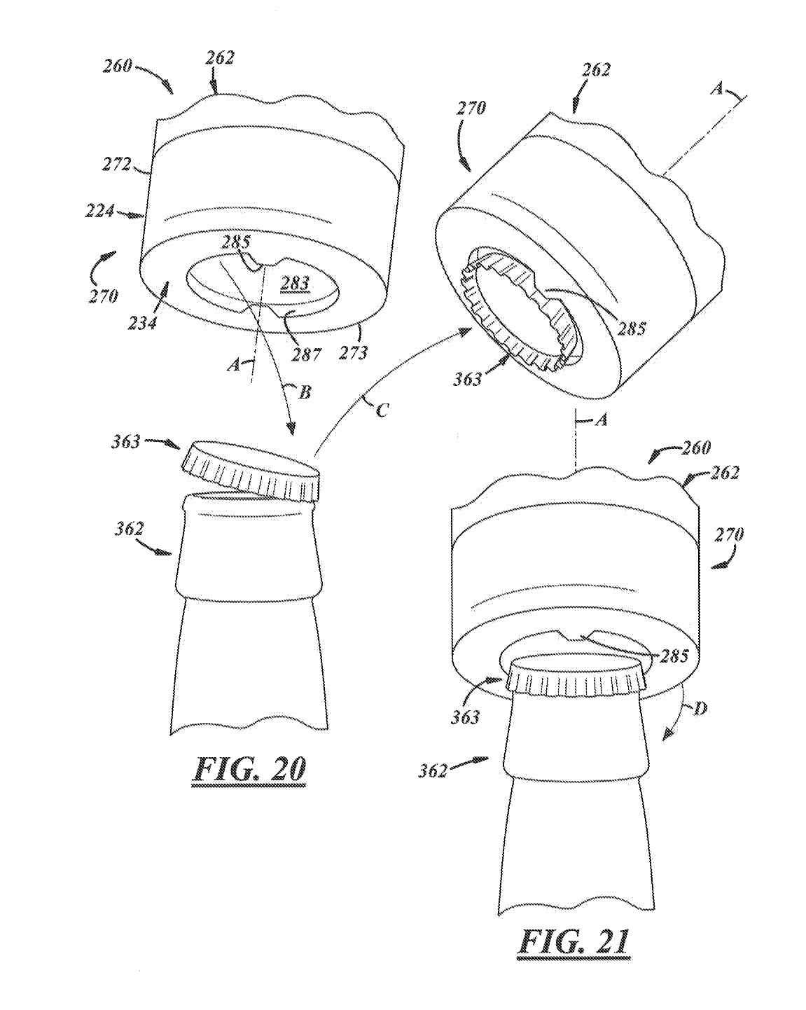

FIGS. 20-21 show another illustrative embodiment of a server 260 including a container 262 and a shell or thermal core 270 coupled to the container 262. This embodiment is similar in many respects to the embodiment of FIGS. 1-19 and like numerals among the embodiments generally designate like or corresponding elements throughout the several views of the drawing figures. Accordingly, the descriptions of the embodiments are incorporated into one another, and description of subject matter common to the embodiments generally may not be repeated here.

Referring to FIG. 20, the core 270 may be substantially similar to the core of the previously disclosed embodiment, except a bottom wall 234 may include a different pocket 283. In this embodiment, the pocket 283 may include diametrically opposed lugs or projections 285 extending radially inwardly from a radially inwardly facing surface 287 to engage and remove a closure 363 from a container 362. The closure 363 may include a crown closure, which may be crimped to the container 362. As shown in the illustrated embodiment, the core 270 may be used to remove the closure 363 of a different container 362. But in another embodiment, the core 270 may be removed from the container 262 and used to remove a closure (not shown) of the same container 262 from which the core 270 was removed. The bottom wall 234 may be a separate component coupled in any suitable manner to a body 224 of the core 270, for example, at a lower end 273 thereof. In another embodiment, the bottom wall 234 may be an integral portion of the body 224.

In any case, during use, the bottom wall 234 is positioned over the closure 363 on the container 362 as represented by arrow B, and the closure 363 inserted into the pocket 283 and engaged with one or both of the projections 285. Also, the core 270 (and container 262) may be pivoted across its axis A relative to the container 362 to remove or uncouple the closure 363 from the container 362, for example, in a pry-off manner as represented by arrow C. In the illustrated example, the closure 363 may be retained in the pocket 283. FIG. 20 is merely schematic and, thus, those of ordinary skill in the art will understand that one or both of the projections 285 may engage any suitable portion(s) of the closure 363, for example, an axially lower edge thereof so as to pry the closure 363 off the container 362.

Thereafter, as shown in FIG. 21, the closure 363 may be returned to the container 362. For example, the core 270 (and container 262) may be pivoted across its axis A relative to the container 362 to reseat or recouple the closure 363 to the container 362, for example, in a press-on manner as represented by arrow D.

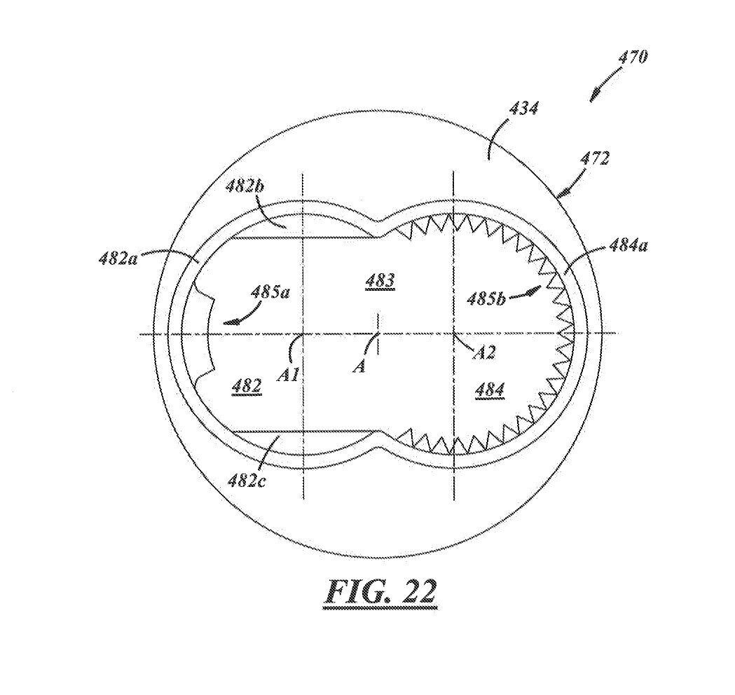

FIG. 22 shows another illustrative embodiment of a shell or thermal core 470. This embodiment is similar in many respects to the embodiment of FIGS. 1-21 and like numerals among the embodiments generally designate like or corresponding elements throughout the several views of the drawing figures. Accordingly, the descriptions of the embodiments are incorporated into one another, and description of subject matter common to the embodiments generally may not be repeated here.

The thermal core 470 may provided with a combination of twist-off and pry-off features as will be discussed in greater detail herein below. The thermal core 470 includes a body having a central longitudinal axis A, a generally axially extending circumferential outer wall 472, and a bottom wall 434. The bottom wall 434 may include a multi-functional pocket 483 to engage and remove a closure from a container (not shown). The pocket 483 may include laterally spaced and diametrically overlapping semi-circumferential pockets 482, 484, for instance, a first or pry-off pocket 482 in open communication with a second or twist-off pocket 484.

The first pocket 482 may include a central longitudinal axis A1, a semi-circumferential wall 482a, a lug 485a extending radially inwardly from the wall to engage an inside edge of a closure (not shown), and diametrically opposed ledges 482b,c that may extend chordally with respect to the semi-circumferential wall 482a to engage an outside surface of the closure. The wall 482a, the lug 485a, and the ledges 482b,c may be recessed below a bottom surface of the bottom wall 434.

The second pocket 484 may include a central longitudinal axis A2, a semi-circumferential wall 484a with a pattern in a shape corresponding to a radially outer profile of a crown closure (not shown). For example, the pocket 484 may have a corrugated or serrated circumferential internal profile 485b in a radially inwardly facing surface of the wall 484a. The profile 485b may include a circumferential array of radially inwardly extending projections circumferentially interspersed with radially outwardly extending reliefs that may correspond to an outer circumferential profile of a crown closure or cap (not shown).

The pockets 482, 484 are in open communication with one another to establish the multi-functional pocket 483. For instance, the semi-circumferential walls 482a, 484a are joined at two locations where the diameters of the walls 482a, 484a intersect.

In use, the core 470 may be positioned over a container having a closure so that the bottom wall 434 is positioned over the closure. In one example, a pry off closure of the container may be inserted into the pry-off pocket 482 such that a lower edge of the closure fits under the lug 485a and then the container may be moved across axis A1 so as to engage the upper side of the closure against the ledges 482b,c so as to pry the closure off the container. In another example, a twist-off closure of a container may be inserted into the twist-off pocket 484 and engaged with the serrated profile 485b, and then the core 470 may be rotated about axis A2 to remove the closure from the container, for example, in a twist-off or unthreading manner.

In yet another embodiment, the multi-functional pocket 483 instead may be provided in a bottom wall of a container or in any other suitable wall of a container, in a wall of a container closure removal tool like a combination key fob and bottle opener, in a wall of a stand-alone bottle opener tool, or in a wall of any other suitable product. As used herein, the term “wall” includes a product wall, body, or any other suitable product structure in which closure remover features may be provided.

In the embodiments of FIGS. 17-22, there are disclosed different means for engaging a closure and removing the closure from a container neck finish. The engaging and removing means instead may include less than a completely circumferential twist-off style serrated pattern, more or less radially inwardly extending pry-off lugs, a slot defined by facing surfaces (curved and/or straight) between which a portion of a closure may be inserted for pry-off removal, multiple different types of such means incorporated in one core, or any other suitable pry-off and/or twist-off features.

There thus has been disclosed a container thermal core and closure remover that fully satisfies all of the objects and aims previously set forth. The disclosure has been presented in conjunction with several exemplary embodiments, and modifications and variations have been suggested. Other modifications and variations readily will suggest themselves to persons of ordinary skill in the art in view of the foregoing description. The disclosure is intended to embrace all such modifications and variations as fall within the spirit and broad scope of the appended claims.

1. A product that includes:
a container having a body with a sidewall, a base, at least one external engagement element on the sidewall or the base, a neck finish, and a closure on the neck finish, and
a thermal core that includes a hollow body with at least one internal engagement element for engaging the external engagement element on the container to retain the thermal core on the container, a central portion for heat-transfer with the base, a thermal medium within the hollow body, a bottom wall on the hollow body, and at least one pocket in the bottom wall with means for engaging the closure and removing the closure from the neck finish.

2. The product set forth in claim 1 wherein the engaging and removing means includes a circumferential pattern corresponding in shape to a radially outer profile of a crown closure.

3. The product set forth in claim 1 wherein the engaging and removing means includes at least one lug.

4. The product set forth in claim 1 wherein the bottom wall is a component separate from the body and sealingly coupled to the body.

5. The product set forth in claim 4 wherein the body includes a lower end and an annular internal recess to accept a radially outer portion of the bottom wall, such that the bottom wall is axially recessed within the body.

6. The product set forth in claim 1 wherein the bottom wall includes a base portion extending radially inwardly from the body, and a domed portion extending radially inwardly from the base portion and establishing the pocket.

7. The product set forth in claim 6, wherein the bottom wall, including the domed portion, is axially spaced from a lower end of the body so as to be axially recessed within the body.

8. The product set forth in claim 1, wherein the bottom wall is axially flush with a lower end of the body.

9. The product set forth in claim 1, wherein the container is of glass, plastic, or metal construction, the hollow body is of plastic construction, and the thermal medium comprises a saline solution, a refrigerant, water, oil, or sand.

10. The product set forth in claim 1 wherein the pocket includes laterally spaced and diametrically overlapping semi-circumferential pockets, a first of which includes container closure pry-off features and a second of which includes container closure twist-off features.

11. The product set forth in claim 10 wherein the first pocket includes a semi-circumferential wall, a lug extending radially inwardly from the wall to engage an inside edge of a closure, and diametrically opposed ledges that may extend chordally with respect to the semi-circumferential wall to engage an outside surface of the closure.

12. The product set forth in claim 10 wherein the second pocket includes a semi-circumferential wall with pattern in a shape corresponding to a radially outer profile of a crown closure.

13. A thermal core that includes:
a hollow body with at least one engagement element for engaging a corresponding engagement element on a container;
a central portion for heat-transfer with a container base;
a thermal medium within the hollow body;
a bottom wall on the hollow body;
a domed portion in the bottom wall; and
a pocket in the domed portion having at least one of twist-off features or pry-off features.

14. The thermal core set forth in claim 13 wherein the twist-off features include a serrated circumferential pattern in a radially inwardly facing surface of the domed portion.

15. The thermal core set forth in claim 14, wherein the circumferential pattern corresponds in shape to a radially outer profile of a crown closure.

16. The thermal core set forth in claim 13 wherein the bottom wall is a component separate from the body and sealingly coupled to the body.

17. The thermal core set forth in claim 16 Wherein the body includes a lower end and an annular internal recess to accept a radially outer portion of the bottom wall, such that the bottom wall is axially recessed within the body.

18. The thermal core set forth in claim 13 wherein the bottom wall, including the domed portion, is axially spaced from a lower end of the body so as to be axially recessed within the body.

19. The thermal core set forth in claim 13 wherein the pry-off features include at least one lug extending radially inwardly from a radially inwardly facing surface of the domed portion.

20. The thermal core set forth in claim 19, wherein the lug includes diametrically opposed lugs.

21. The thermal core set forth in claim 13 wherein the pocket includes laterally spaced and diametrically overlapping semi-circumferential pockets including:
a first pocket having a semi-circumferential wall, a lug extending radially inwardly from the wall to engage an inside edge of a closure, and diametrically opposed ledges that extend chordally with respect to the semi-circumferential wall to engage an outside surface of the closure, and
a second pocket having a semi-circumferential wall with a pattern in a shape corresponding to a radially outer profile of a crown closure.

22. A product to remove a closure from a container, that includes
a wall; and
a multi-functional pocket in the wall that includes laterally spaced and diametrically overlapping semi-circumferential pockets including a first pocket having container closure pry off features and a second pocket having container closure twist-off features.

23. The product set forth in claim 2.2 wherein the first pocket includes a semi-circumferential wall, a lug extending radially inwardly from the wall to engage an inside edge of a closure, and diametrically opposed ledges that may extend chordally with respect to the semi-circumferential wall to engage an outside surface of the closure.

24. The product set forth in claim 22 wherein the second pocket includes a semi-circumferential wall with pattern in a shape corresponding to a radially outer profile of a crown closure.

25. The product set forth in claim 22 wherein the product is a thermal core of a beverage server.
